(19) United States
(12) Patent Application Publication
(10) Pub. No.: US 2024/0127118 A1
(43) Pub. Date: Apr. 18, 2024

(54) INFORMATION PROCESSING DEVICE, NON-TRANSITORY COMPUTER-READABLE MEDIUM, AND INFORMATION PROCESSING METHOD

(71) Applicant: Mitsubishi Electric Corporation, Tokyo (JP)

(72) Inventor: Jikang LIU, Tokyo (JP)

(73) Assignee: Mitsubishi Electric Corporation, Tokyo (JP)

(21) Appl. No.: 18/394,939

(22) Filed: Dec. 22, 2023

Related U.S. Application Data
(63) Continuation of application No. PCT/JP2021/024512, filed on Jun. 29, 2021.

(51) Int. Cl. G06N 20/00

(52) U.S. Cl. CPC G06N 20/00

(57) ABSTRACT

An information processing device includes a data collecting unit that collects sensor data from a plurality of sensors; a determination-data generating unit that generates determination batch data including learned data and unlearned data, the learned data being learning data that has already been used to learn a learning model for making a prediction based on the sensor data, the unlearned data corresponding to the sensor data; and a relearning determining unit that calculates propensity scores for the learned data and the unlearned data by using a covariate affecting a result of the prediction to perform stratification by allocating the learned data and the unlearned data to a plurality of layers, and to determine whether or not the learning model is to be relearned by using a frequency of appearance of a critical layer and a frequency of appearance of critical data from a result of the stratification.

### CROSS REFERENCE TO RELATED APPLICATION

This application is a continuation application of International Application No. PCT/JP2021/024512 having an international filing date of Jun. 29, 2021.

### BACKGROUND OF THE INVENTION

### 1. Field of the Invention

The disclosure relates to an information processing device, a non-transitory computer-readable medium, and an information processing method.

### 2. Description of the Related Art

In recent years, various predictions have been made using learning models in machine learning.

For example, traffic demand prediction techniques based on statistical methods have been devised to predict demand for public transportation such as trains or buses, and have been applied to reduce traffic congestion at stations and adjust the operation capacity of trains or buses.

As a conventional technique, a traffic-demand prediction device has been disclosed that can predict future human flow data on the basis of an appropriate human flow prediction model that is dynamically updated (for example, refer to Patent Literature 1). The human flow data here refers to the number of people passing through a facility in a unit time.
Patent Literature 1: Japanese Patent Application Publication No. 2019-040475

### SUMMARY OF THE INVENTION

Conventional traffic-demand prediction devices use a learning model, such as a human flow prediction model based on a multiple regression model, to predict new human flow data, and uses the average prediction accuracy of this data to determine whether or not to relearn the parameters of the learning model.

Therefore, it is not possible to consider data such as rare scenes that occur infrequently, represented by extreme weather or traffic accidents, even if such data is critical data. For this reason, data that is used as a condition for determining the relearning of the learning model includes a smaller amount of critical data such as rare scenes, and this results in highly biased data. Therefore, conventional techniques have a problem of not being able to determine the relearning conditions of a learning model with valid conditions.

Accordingly, it is an object of one or more aspects of the disclosure to prevent a significant bias in critical data and to be able to determine whether or not a learning model is to be relearned under more valid conditions.

An information processing device according to an aspect of the disclosure includes: a processor to execute a program; and a memory to store the program which, when executed by the processor, performs processes of, collecting sensor data from a plurality of sensors; generating determination batch data including learned data and unlearned data, the learned data being learning data that has already been used to learn a first learning model for making a prediction based on the sensor data, the unlearned data corresponding to the sensor data; calculating propensity scores for the learned data and the unlearned data by using a covariate affecting a result of the prediction to perform stratification by allocating the learned data and the unlearned data to a plurality of layers; and determining whether or not the first learning model is to be relearned by using a frequency of appearance of a critical layer and a frequency of appearance of critical data from a result of the stratification, the critical layer being a layer determined to have a high degree of importance out of the plurality of layers, the critical data being data determined to have a high degree of importance out of the unlearned data and the learned data.

A non-transitory computer-readable medium that stores therein a program according to an aspect of the disclosure causes a computer to execute processes of: collecting sensor data from a plurality of sensors; generating determination batch data including learned data and unlearned data, the learned data being learning data that has already been used to learn a first learning model for making a prediction based on the sensor data, the unlearned data corresponding to the sensor data; calculating propensity scores for the learned data and the unlearned data by using a covariate affecting a result of the prediction to perform stratification by allocating the learned data and the unlearned data to a plurality of layers; and determining whether or not the first learning model is to be relearned by using a frequency of appearance of a critical layer and a frequency of appearance of critical data from a result of the stratification, the critical layer being a layer determined to have a high degree of importance out of the plurality of layers, the critical data being data determined to have a high degree of importance out of the unlearned data and the learned data.

An information processing method according to an aspect of the disclosure includes: collecting sensor data from a plurality of sensors; generating determination batch data including learned data and unlearned data, the learned data being learning data that has already been used to learn a learning model for making a prediction based on the sensor data, the unlearned data corresponding to the sensor data; calculating propensity scores for the learned data and the unlearned data by using a covariate affecting a result of the prediction to perform stratification by allocating the learned data and the unlearned data to a plurality of layers; and determining whether or not to the learning model is to be relearned by using a frequency of appearance of a critical layer and a frequency of appearance of critical data from a result of the stratification, the critical layer being a layer determined to have a high degree of importance out of the plurality of layers, the critical data being data determined to have a high degree of importance out of the unlearned data and the learned data.

According to one or more aspects of the disclosure, it is possible to prevent a significant bias in critical data and to determine whether or not a learning model is to be relearned under more valid conditions.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of an information processing system;

FIG. 2 is a schematic diagram illustrating an example of an LSTM model;

FIGS. 3A to 3C are schematic diagrams for explaining processing executed by a relearning determining unit;

FIG. 4 is a schematic diagram for explaining the frequency of appearance of a critical layer;

FIG. 5 is a schematic diagram for explaining the frequency of appearance of critical data;

FIG. 6 is a block diagram illustrating a hardware configuration example of an information processing device; and

FIG. 7 is a flowchart illustrating a process executed when an information processing device relearns a prediction model.

### DETAILED DESCRIPTION OF THE INVENTION

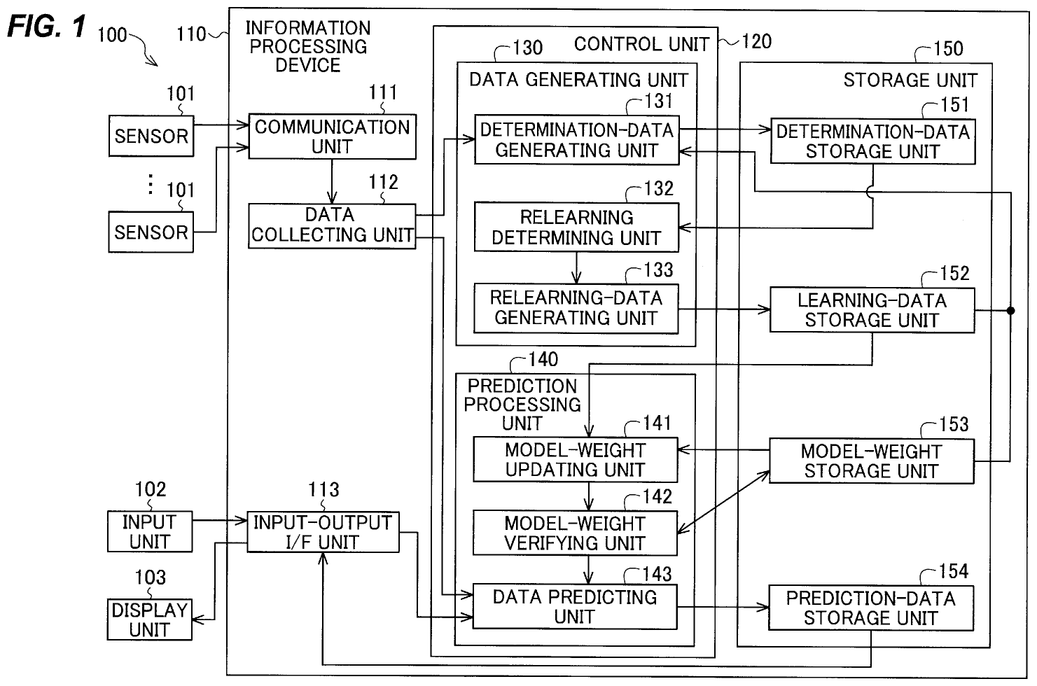

FIG. 1 is a block diagram schematically illustrating a configuration of an information processing system 100.

Here, the information processing system 100 is described as a traffic demand prediction system that predicts demand for public transportation such as trains or buses.

The information processing system 100 includes sensors 101, an input unit 102, a display unit 103, and an information processing device 110.

The sensors 101 generate sensor data indicating external information related to traffic demand and transmit the sensor data to the information processing device 110. Although the number of sensors 101 is not particularly limited, it is assumed here that multiple sensors 101 are provided.

The input unit 102 accepts input of various instructions for the information processing device 110. The inputted instructions are sent to the information processing device 110.

For example, the input unit 102 accepts input of the date of performing demand prediction.

Here, the input unit 102 can be implemented by an input device, such as a keyboard or a mouse.

The display unit 103 outputs the processing result from the information processing device 110.

For example, the display unit 103 displays the result of the prediction of future traffic demand made by the information processing device 110.

Here, the display unit 103 is specifically implemented by a display such as a liquid crystal display.

The information processing device 110 processes the external information indicated by the sensor data obtained from the sensors 101 in accordance with an instruction from the input unit 102, and causes the display unit 103 to display the processing result.

For example, the information processing device 110 uses a prediction model, which is a pre-learned learning model, to predict traffic demand on a date inputted to the input unit 102 on the basis of the external information indicated by the sensor data, and causes the display unit 103 to display the prediction result. In the present embodiment, the information processing device 110 functions as a traffic-demand predicting device. The prediction model is also referred to as first learning model.

Here, the way the prediction model is learned differs between when a pre-learned weight is set and when a pre-learned weight is not set.

When no pre-learned weight is set, the prediction model is initialized with the default weight. The default weight is, for example, the weight matrix when all vectors are set to zero. Model input data converted from sensor data acquired in advance is used as learning data to learn the prediction model. The weight learned in this way is stored in the information processing device 110.

When a pre-learned weight is set, the prediction model is initialized with the most recently stored weight. Model input data converted from sensor data acquired in advance is used as learning data to learn the prediction model. The weight learned in this way is stored in the information processing device 110.

The information processing device 110 includes a communication unit 111, a data collecting unit 112, an input-output interface unit (input-output I/F unit) 113, a control unit 120, and a storage unit 150.

The communication unit 111 receives sensor data from the sensors 101. The received sensor data is given to the data collecting unit 112.

The data collecting unit 112 collects sensor data from the multiple sensors 101.

For example, the data collecting unit 112 receives sensor data from the communication unit 111, converts the sensor data into model input data adapted to the input format of the prediction model, and gives the model input data to the control unit 120.

The input-output I/F unit 113 is connected to the input unit 102 or the display unit 103.

For example, the input-output I/F unit 113 receives date data indicating a date of performing demand prediction from the input unit 102 and gives the date data to the control unit 120.

The input-output I/F unit 113 converts prediction result data outputted from a prediction-data storage unit 154 into signal data that can be used by the display unit 103 and outputs the signal data to the display unit 103.

The control unit 120 controls the processing executed by the information processing device 110.

The control unit 120 includes a data generating unit 130 and a prediction processing unit 140.

The data generating unit 130 generates determination batch data for determining the relearning of the prediction model. The data generating unit 130 also determines whether or not to relearn the prediction model by using the determination batch data. When it is determined that the prediction model is to be relearned, the data generating unit 130 generates relearning batch data for relearning the prediction model.

The data generating unit 130 includes a determination-data generating unit 131, a relearning determining unit 132, and a relearning-data generating unit 133.

The determination-data generating unit 131 generates determination batch data including learned data, which is learning data that has already been used to learn the prediction model, and unlearned data corresponding to sensor data. Here, the unlearned data is model input data converted from sensor data.

Specifically, the determination-data generating unit 131 generates determination batch data for determining whether or not to relearn the prediction model with the unlearned data, which is model input data converted from sensor data given from the data collecting unit 112 and not used for learning of the prediction model, the learned data, which is learned model input data stored in the storage unit 150, and the weight of a past optimal prediction model stored in the storage unit 150. The determination batch data is stored in the storage unit 150.

Here, the number of learned data pieces is constant, and the learned data is, for example, critical data of a predetermined period in the past (for example, a few weeks). Critical data is data having a high degree of importance.

The relearning determining unit 132 reads the determination batch data stored in the storage unit 150 and uses the parameters of the past optimal model to evaluate the prediction accuracy of each piece of the unlearned data and learned data.

For example, the relearning determining unit 132 stratifies each of the unlearned data and the learned data with covariate data included in the model input data, and uses the degree of importance of each layer and the degrees of importance of the unlearned data and learned data allocated to the respective layers to determine the relearning.

Here, the relearning determining unit 132 calculates propensity scores for the learned data and the unlearned data corresponding to the sensor data by using covariates that affect the result of the prediction, to perform stratification by allocating the learned data and the unlearned data to multiple layers. Then, based on the stratification result, the relearning determining unit 132 uses the frequency of appearance of critical layers, which are layers determined to have a high degree of importance out of the multiple layers, and the frequency of appearance of critical data, which is data determined to have a high degree of importance out of the unlearned data and the learned data, and determines whether or not to relearn the prediction model.

A specific processing example of the relearning determining unit 132 will now be explained.

First, stratification based on the relearning determining unit 132 will be explained.

Here, the relearning decision unit 132 calculates propensity scores through a causal inference technique that analyzes the propensity of guidance measures by using a polynomial logit model or a linear multiple regression model, and performs dimensional reduction of the covariate data to perform stratification.

Specifically, when there is a change in the degree of congestion at a station or in a vehicle due to an external factor such as a traffic accident or extreme weather, station attendants direct the flow of people through measures such as in-vehicle announcements and manual guidance. The relearning determining unit 132 collects the history of these guidance measures, analyzes the covariate data such as weather, service information, or event information with covariates, and calculates the probabilities of the guidance measures with a gradient boosting decision tree or a polynomial logit model. The probabilities of the guidance measures calculated with the covariates are defined as propensity scores of the guidance measures. The value of a propensity score is a real number between zero and one. In the analysis of causality, a covariate is a factor that is observed in addition to the factor being evaluated and affects the causality. Here, a covariate is a variable affecting traffic demand, the degree of train congestion, or the like.

The relearning determining unit 132 then sets a threshold for each layer by using a propensity score of a guidance measure and stratifies the unlearned data and the learned data. For example, data having a propensity score equal to or greater than zero and smaller than 0.03 is allocated to a layer of low measure probability. Data having a propensity score equal to or greater than 0.3 and smaller than 0.6 is allocated to a layer of medium measure probability. Data having a propensity score equal to or greater than 0.6 and equal to or smaller than one is allocated to a layer of high measure probability.

This stratification is an example, and, for example, the threshold for stratification and the number of layers can be adjusted depending on the balance of the covariates of the actual real data for learning.

Next, the relearning determining unit 132 calculates the average prediction accuracies of the unlearned data and the learned data allocated to the respective layers and further calculates the difference in the prediction accuracies of the unlearned data and the learned data allocated to the respective layers.

Then, when there is a layer whose calculated average prediction accuracy is equal to or lower than a predetermined threshold or when there is a layer whose difference in the calculated prediction accuracy is equal to or more than a predetermined threshold, the relearning determining unit 132 labels such a layer as critical and labels all pieces of data contained in such a layer as critical. Here, the layer labeled as critical is a critical layer. The data labeled as critical is critical data.

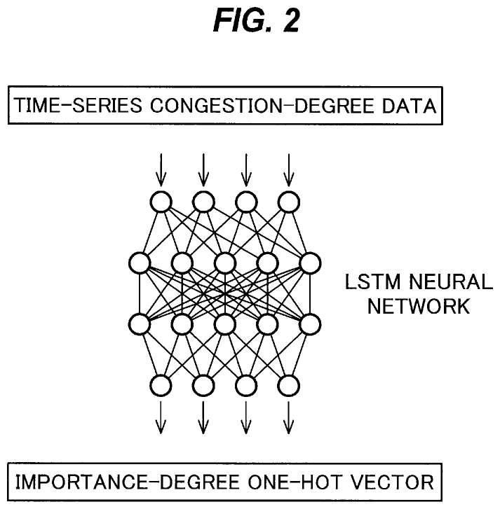

The relearning determining unit 132 determines whether or not the data contained in layers having calculated average prediction accuracies higher than a predetermined threshold and the data contained in layers having differences in calculated prediction accuracies smaller than a predetermined threshold are critical data. This determination can be made by using a deep learning model in machine learning. This deep learning model is a learning model different from the prediction model. This deep learning model is also referred to as second learning model. The parameters of this deep learning model are those that have been learned by preparing learning data in advance. Here, as an example of a deep learning model for critical data determination, the long short-term memory (LSTM) model illustrated in FIG. 2 can be used. The input of this model is a time-series change amount in traffic demand prediction, which is time-series data, and the output of this model is an importance-degree one-hot vector.

The relearning determining unit 132 then determines that the prediction model is to be relearned when the frequency of appearance of critical layers is equal to or higher than a predetermined threshold or when the frequency of appearance of critical data is equal to or higher than a predetermined threshold.

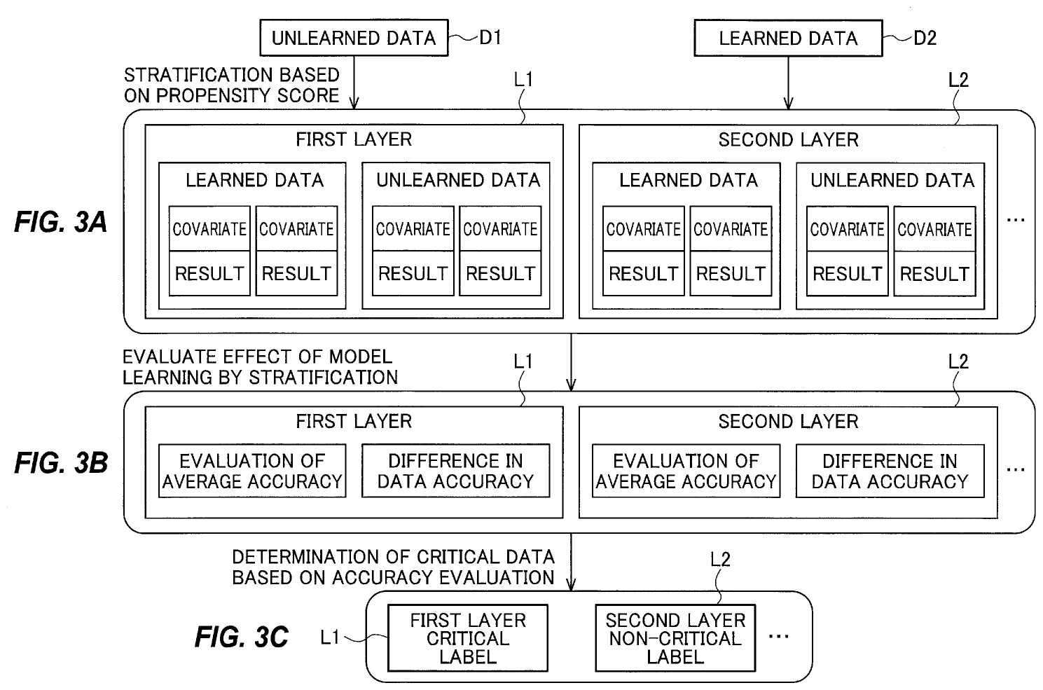

FIGS. 3 to 5 are schematic diagrams for explaining processing executed by the relearning determining unit 132.

The relearning determining unit 132 reads the determination batch data stored in the storage unit 150, calculates a propensity score for each of unlearned data D1 and learned data D2 by using the parameters of a past optimal model, and performs dimensional reduction of the covariate data to perform stratification.

Thus, as illustrated in FIG. 3A, the learned data and the unlearned data are allocated to a first layer L1, a second layer L2, . . .

Next, as illustrated in FIG. 3B, the relearning determining unit 132 calculates the average prediction accuracies of the unlearned data and the learned data allocated to the respective layers L1, L2, . . . , and further calculates the differences in the prediction accuracies of the unlearned data and the learned data allocated to the respective layers.

The relearning determining unit 132 then uses the calculated average prediction accuracies and the calculated differences in the prediction accuracies to label each layer as critical or non-critical. In FIG. 3C, the first layer L1 is labeled as critical, and the second layer L2 is labeled as non-critical.

The relearning determining unit 132 also labels all data pieces contained in a layer labeled as critical. The relearning determining unit 132 then determines whether or not each piece of data contained in the layer labeled as non-critical is critical data, labels the data determined to be critical data as critical, and labels the data not determined to be critical data as non-critical. A layer labeled as non-critical is also referred to as non-critical layer, and data labeled as non-critical is also referred to as non-critical data.

The relearning determining unit 132 then determines that the prediction model is to be relearned when the frequency of appearance of critical layers, which are layers labeled as critical, is equal to or higher than a predetermined threshold or when the frequency of appearance of critical data is equal to or higher than a predetermined threshold.

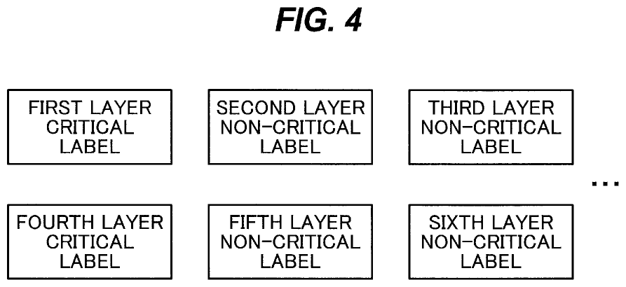

For example, as illustrated in FIG. 4, when the frequency of appearance of critical layers is 1/3 and the threshold for the frequency of appearance of critical layers is 0.5, the frequency of appearance of critical layers is not higher than a threshold.

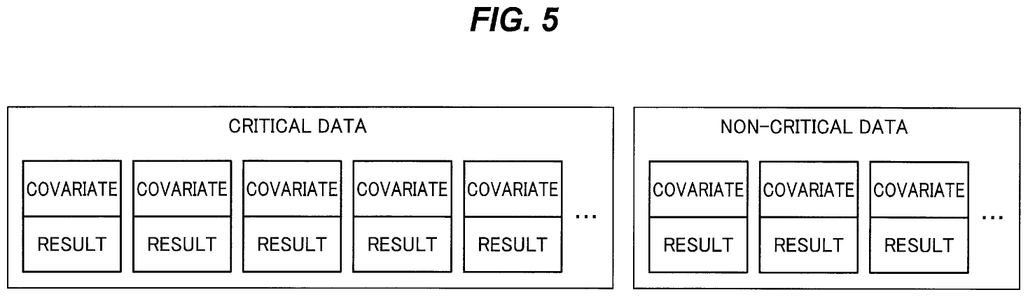

On the other hand, when the frequency of appearance of critical data is 5/8, as illustrated in FIG. 5, and the threshold for the frequency of appearance of critical data is 0.5, the frequency of appearance of critical data is higher than a threshold.

In such a case, the relearning determining unit 132 determines that the prediction model has not been properly learned and that the weight of the prediction model needs to be relearned. Here, when the frequency of appearance of critical layers is higher than a threshold, it can be determined that the critical data is too biased toward layers containing critical data, and the weight of the prediction model is relearned to prevent such a bias.

In the examples of FIGS. 4 and 5, relearning the weight of the prediction model is not necessary on the basis of the frequency of appearance of critical layers, but the frequency of appearance of critical data is increased due to a bias in the distribution of the critical data. Therefore, in the example illustrated in FIG. 5, it is determined that the weight of the prediction model needs to be relearned.

When the relearning determining unit 132 determines that relearning is necessary, the relearning-data generating unit 133 re-samples the learning data and the unlearned data in the same proportion as that of the data in each layer to generate the relearning batch data, and causes the storage unit 150 to store the relearning batch data.

The prediction processing unit 140 makes a prediction based on sensor data by using a prediction model that is a learning model. The prediction processing unit 140 relearns the prediction model when the relearning determining unit 132 determines that the prediction model is to be relearned.

The prediction processing unit 140 includes a model-weight updating unit 141, a model-weight verifying unit 142, and a data predicting unit 143.

The model-weight updating unit 141 is a relearning unit that reads the relearning batch data stored in a learning-data storage unit 152 and relearns the prediction model by using the relearning batch data.

For example, the model-weight updating unit 141 updates the weight of the prediction model stored in a model-weight storage unit 153 by using the relearning batch data.

The model-weight verifying unit 142 determines whether or not the weight updated by the model-weight updating unit 141 is optimal. For example, to reduce the prediction error of an updated weight, the model-weight verifying unit 142 determines that the updated weight is optimal when the prediction error of the updated weight is smaller than the prediction error of a past optimal weight.

The model-weight verifying unit 142 then gives the updated weight to the data predicting unit 143 when it is determined that the updated weight is optimal and gives the past optimal weight when it is determined that the updated weight is not optimal.

The data predicting unit 143 is a predicting unit that uses the weight provided by the model-weight verifying unit 142 to predict traffic demand on the date inputted to the input unit 102 on the basis of the sensor data collected by the data collecting unit 112. The data predicting unit 143 then causes the storage unit 150 to store prediction result data indicating the result of the prediction.

The storage unit 150 stores programs and data necessary for the processing executed by the information processing device 110.

The storage unit 150 includes a determination-data storage unit 151, the learning-data storage unit 152, the model-weight storage unit 153, and the prediction-data storage unit 154.

The determination-data storage unit 151 stores the determination batch data generated by the determination-data generating unit 131.

The learning-data storage unit 152 stores the relearning batch data generated by the relearning-data generating unit 133. It is assumed that the learning data already used for learning of the prediction model is also stored in the learning-data storage unit 152 as learned data. Therefore, the relearning batch data also becomes learned data after it is used to relearn the prediction model.

The model-weight storage unit 153 stores the weight of the prediction model.

The prediction-data storage unit 154 stores demand prediction data indicating a demand prediction, which is the result of the prediction made by the data predicting unit 143.

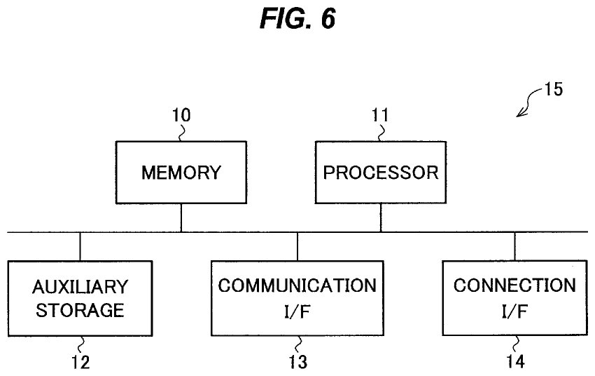

The information processing device 110 described above can be implemented by a computer 15 that includes a volatile or nonvolatile memory 10, a processor 11 such as a central processing unit (CPU), an auxiliary storage 12 such as a hard disk drive (HDD) or a solid-state drive (SSD), a communication I/F 13 such as a network interface card (NIC), and a connection I/F 14 such as a universal serial bus (USB), as illustrated in FIG. 6.

For example, the data collecting unit 112 and the control unit 120 can be implemented by the processor 11 executing the programs stored in the memory 10.

The storage unit 150 can be implemented by the memory 10 or the auxiliary storage 12.

The communication unit 111 can be implemented by the communication I/F 13.

The input-output I/F unit 113 can be implemented by the connection I/F 14.

The above-described programs may be provided via a network or may be recorded and provided on a recording medium or non-transitory computer-readable medium. That is, such programs may be provided as, for example, program products.

The operation of the information processing device 110 will now be explained.

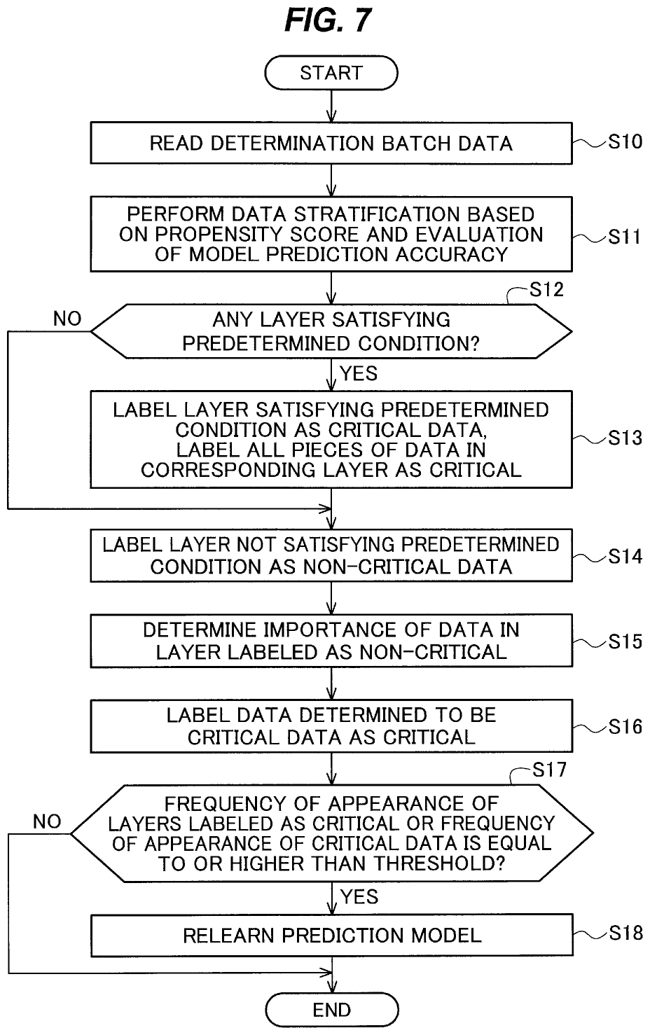

FIG. 7 is a flowchart illustrating a process executed when the information processing device 110 relearns a prediction model.

First, the relearning determining unit 132 reads determination batch data from the determination-data storage unit 151 (step S10). The determination batch data is updated, for example, once in a predetermined period (e.g., a few hours), and when the determination batch data is updated, the relearning determining unit 132 determines whether or not to relearn the prediction model.

Next, the relearning determining unit 132 reduces the number of dimensions of the covariate data included in the unlearned data and the learned data in the determination batch data read in step S10 by one dimension by using a statistical causal inference technique that analyzes measure propensity with a polynomial logit model or linear multiple regression model, and performs stratification (step S11). The relearning determining unit 132 calculates the average prediction accuracy of each stratified layer and the difference in the prediction accuracy between the unlearned data and the learned data.

Next, the relearning determining unit 132 determines whether or not there is a layer having an average prediction accuracy calculated in step S11 that is higher than a predetermined threshold or a layer having a difference in the prediction accuracy calculated in step S11 that is higher than a predetermined threshold (step S12). If there is such a layer (Yes in step S12), the process proceeds to step S13, and if there is no such layer (No in step S12), the process proceeds to step S14.

In step S13, the layers having an average prediction accuracy calculated in step S11 that is higher than a predetermined threshold and the layers having a difference in the prediction accuracy calculated in step S11 that is higher than a predetermined threshold are labeled as critical, and all pieces of data contained in such layers are labeled as critical.

In step S14, the layers having average prediction accuracies calculated in step S11 that are lower than a predetermined threshold and the layers having differences in the prediction accuracies calculated in step S11 that are lower than a predetermined threshold are labeled as non-critical.

Next, the relearning determining unit 132 uses a supervised LSTM model to determine whether or not the data contained in the non-critical layers becomes critical data (step S15).

The relearning determining unit 132 then labels the data determined to be critical data as critical in step S15. The data labeled as critical is also referred to as critical data.

The relearning determining unit 132 then determines whether or not at least one of the following conditions is satisfied: a first condition that is the frequency of appearance of critical layers equal to or higher than a predetermined threshold (for example, 0.5) and a second condition that is the frequency of appearance of critical data equal to or higher than a predetermined threshold (for example, 0.5) (step S17). If at least one of the first and second conditions is satisfied (Yes in step S17), the process proceeds to step S18, and if neither the first condition nor the second condition is satisfied (No in step S17), the process ends.

In step S18, the relearning determining unit 132 determines that the prediction model is to be relearned, the relearning-data generating unit 133 generates relearning batch data, and the model-weight updating unit 141 relearns the prediction model on the basis of the relearning batch data.

According to the above-described embodiment, not only the frequency of appearance of critical data but also the frequency of appearance of critical layers is referred to determine whether or not to relearn the prediction model, so that the critical data can be prevented from being too biased toward one layer. Therefore, whether or not to relearn the prediction model can be determined under more valid conditions.

According to the above-described embodiment, since relearning is performed intensively by using critical data, the degree of convergence of the learning of a prediction model and the prediction accuracy of rare scene data or critical data with a high degree of congestion can be improved.

Furthermore, since the amount of non-critical data in the relearning batch data can be reduced, the amount of data used in relearning can be reduced.

What is claimed is:

1. An information processing device comprising:
a processor to execute a program; and
a memory to store the program which, when executed by the processor, performs processes of,
collecting sensor data from a plurality of sensors;
generating determination batch data including learned data and unlearned data, the learned data being learning data that has already been used to learn a first learning model for making a prediction based on the sensor data, the unlearned data corresponding to the sensor data;
calculating propensity scores for the learned data and the unlearned data by using a covariate affecting a result of the prediction to perform stratification by allocating the learned data and the unlearned data to a plurality of layers; and
determining whether or not the first learning model is to be relearned by using a frequency of appearance of a critical layer and a frequency of appearance of critical data from a result of the stratification, the critical layer being a layer determined to have a high degree of importance out of the plurality of layers, the critical data being data determined to have a high degree of importance out of the unlearned data and the learned data.

2. The information processing device according to claim 1, wherein the processor determines that the first learning model is to be relearned when the frequency of appearance of the critical layer is equal to or higher than a predetermined threshold or when the frequency of appearance of the critical data is equal to or higher than a predetermined threshold.

3. The information processing device according to claim 1, wherein the processor determines a layer having average prediction accuracy equal to or lower than a predetermined threshold or a layer whose difference between a prediction accuracy of the unlearned data and a prediction accuracy of the learned data is equal to or larger than a predetermined threshold to be the critical layer of the plurality of layers.

4. The information processing device according to claim 2, wherein the processor determines a layer having average prediction accuracy equal to or lower than a predetermined threshold or a layer whose difference between a prediction accuracy of the unlearned data and a prediction accuracy of the learned data is equal to or larger than a predetermined threshold to be the critical layer of the plurality of layers.

5. The information processing device according to claim 1, wherein the processor determines the unlearned data and the learned data contained in the critical layer to be the critical data.

6. The information processing device according to claim 2, wherein the processor determines the unlearned data and the learned data contained in the critical layer to be the critical data.

7. The information processing device according to claim 3, wherein the processor determines the unlearned data and the learned data contained in the critical layer to be the critical data.

8. The information processing device according to claim 4, wherein the processor determines the unlearned data and the learned data contained in the critical layer to be the critical data.

9. The information processing device according to claim 1, wherein the processor uses a second learning model to determine whether or not the unlearned data and the learned data contained in layers of the plurality of layers other than the critical layer is the critical data, the second learning model being a learning model different from the first learning model.

10. The information processing device according to claim 2, wherein the processor uses a second learning model to determine whether or not the unlearned data and the learned data contained in layers of the plurality of layers other than the critical layer is the critical data, the second learning model being a learning model different from the first learning model.

11. The information processing device according to claim 3, wherein the processor uses a second learning model to determine whether or not the unlearned data and the learned data contained in layers of the plurality of layers other than the critical layer is the critical data, the second learning model being a learning model different from the first learning model.

12. The information processing device according to claim 4, wherein the processor uses a second learning model to determine whether or not the unlearned data and the learned data contained in layers of the plurality of layers other than the critical layer is the critical data, the second learning model being a learning model different from the first learning model.

13. The information processing device according to claim 5, wherein the processor uses a second learning model to determine whether or not the unlearned data and the learned data contained in layers of the plurality of layers other than the critical layer is the critical data, the second learning model being a learning model different from the first learning model.

14. The information processing device according to claim 6, wherein the processor uses a second learning model to determine whether or not the unlearned data and the learned data contained in layers of the plurality of layers other than the critical layer is the critical data, the second learning model being a learning model different from the first learning model.

15. The information processing device according to claim 7, wherein the processor uses a second learning model to determine whether or not the unlearned data and the learned data contained in layers of the plurality of layers other than the critical layer is the critical data, the second learning model being a learning model different from the first learning model.

16. The information processing device according to claim 8, wherein the processor uses a second learning model to determine whether or not the unlearned data and the learned data contained in layers of the plurality of layers other than the critical layer is the critical data, the second learning model being a learning model different from the first learning model.

17. The information processing device according to claim 1, wherein the processor relearns the first learning model when the processor determines that the learning model is to be relearned.

18. A non-transitory computer-readable medium that stores therein a program that causes a computer to execute processes of:
collecting sensor data from a plurality of sensors;
generating determination batch data including learned data and unlearned data, the learned data being learning data that has already been used to learn a learning model for making a prediction based on the sensor data, the unlearned data corresponding to the sensor data;
calculating propensity scores for the learned data and the unlearned data by using a covariate affecting a result of the prediction to perform stratification by allocating the learned data and the unlearned data to a plurality of layers; and
determining whether or not the learning model is to be relearned by using a frequency of appearance of a critical layer and a frequency of appearance of critical data from a result of the stratification, the critical layer being a layer determined to have a high degree of importance out of the plurality of layers, the critical data being data determined to have a high degree of importance out of the unlearned data and the learned data.

19. An information processing method comprising:
collecting sensor data from a plurality of sensors;
generating determination batch data including learned data and unlearned data, the learned data being learning data that has already been used to learn a learning model for making a prediction based on the sensor data, the unlearned data corresponding to the sensor data;
calculating propensity scores for the learned data and the unlearned data by using a covariate affecting a result of the prediction to perform stratification by allocating the learned data and the unlearned data to a plurality of layers; and
determining whether or not to the learning model is to be relearned by using a frequency of appearance of a critical layer and a frequency of appearance of critical data from a result of the stratification, the critical layer being a layer determined to have a high degree of importance out of the plurality of layers, the critical data being data determined to have a high degree of importance out of the unlearned data and the learned data.
